(19) United States
(12) Patent Application Publication
(10) Pub. No.: US 2015/0127306 A1
(43) Pub. Date: May 7, 2015

(54) APPARATUS AND METHOD FOR CREATING A POWER CONSUMPTION MODEL AND NON-TRANSITORY COMPUTER READABLE STORAGE MEDIUM THEREOF

(71) Applicant: Institute for Information Industry, Taipei (TW)

(72) Inventor: Jing-Tian SUNG, Taipei City (TW)

(73) Assignee: Institute for Information Industry, Taipei (TW)

(21) Appl. No.: 14/099,232

(22) Filed: Dec. 6, 2013

(30) Foreign Application Priority Data
Nov. 7, 2013 (TW) 102140460

(51) Int. Cl. G06F 17/50

(52) U.S. Cl. CPC G06F 17/5009
USPC 703/2

(57) ABSTRACT

An apparatus and method for creating a power consumption model and a non-transitory computer readable storage medium thereof are provided. The apparatus is stored with a power consumption datum for each of a target user and a plurality of users. The apparatus selects several users as a group, uses the power consumption data of the users in the group to create a predicted model, calculates a predicted power consumption value for the target user, calculates a difference according to the predicted power consumption value and a real power consumption value, and repeats the aforementioned operations until a criterion has been satisfied. The apparatus selects the groups whose corresponding difference is smaller than a predetermined value and creates a power consumption model by the power consumption data of the users that appear more than one time and the power consumption data of the target user.

### PRIORITY

This application claims priority to Taiwan Patent Application No. 102140460 filed on Nov. 7, 2013, which is hereby incorporated by reference in its entirety.

### FIELD

The present invention relates to an apparatus and a method for creating a power consumption model, and a non-transitory computer readable storage medium thereof. More particularly, the present invention relates to an apparatus and a method for creating a power consumption model for a target user by using power consumption data of non-target users.

### BACKGROUND

As the shortage of resources becomes increasingly serious and the energy prices increase continuously today, energy management has become a great concern of the public. Therefore, it is highly desirable to distribute and use the energy efficiently through intelligent monitoring, management and control.

Energy management may be divided into energy management at the power-supply side and energy management at the power-consuming side. Energy management at the power-supply side is to connect the conventional power-supply networks and renewable energy sources to an intelligent power management network so that a state of supply and demand can be monitored in real time and adjustments can be made duly to achieve the best effect. The objective of energy management at the power-supply side is to ensure the power-supply quality and to reduce costs for power grid establishing and managing. On the other hand, the energy management at the power-consuming side places the emphasis on analyzing power consumption information in real time, predicting the future power consumption demand, and managing the power consumption in conjunction with the electricity pricing policy to avoid unnecessary waste. Through the energy management at the power-consuming side, the electricity charge can be reduced and energy saving can be achieved.

When energy management at the power-consuming side is needed for a user, the conventional technology has to firstly gather power consumption data of this user for a long period of time (e.g., several months, a quarter or a year). Then, a power consumption model is created according to the gathered power consumption data, and the future power consumption amount of the user is predicted according to this power consumption model. As can be known from this, the conventional technology must gather the user's history power consumption information for a long period of time in order to predict the power consumption of the user. However, if energy management services (e.g., predicting power consumption amount and predicting an electricity bill at the end of a month) can only be provided a half or one year later after the user has purchased the energy management product or services, then the user will be less interested in purchasing and using the energy management product or services.

Accordingly, an urgent need exists in the art to provide a solution capable of creating a power consumption model within a short time.

### SUMMARY

To solve the problem with the conventional technology, the present invention provides in certain embodiments an apparatus and a method for creating a power consumption model and a non-transitory computer readable storage medium thereof.

The apparatus provided by certain embodiments of the present invention comprises a storage unit and a processing unit electrically connected to each other. The storage unit is stored with a power consumption datum for each of a plurality of users and a power consumption datum for a target user. The processing unit is configured to execute the following operations: (a) selecting a number of users from the users as a group, (b) creating a predicted model by using the power consumption data of the users in the group, (c) calculating a predicted power consumption value of the target user by using the predicted model, (d) calculating a difference between the predicted power consumption value and an actual power consumption value of the target user, wherein the actual power consumption value is contained in the power consumption datum of the target user, and (e) repeating the operations (a), (b), (c), and (d) until a preset criterion is satisfied. The processing unit further selects those of the groups whose corresponding differences are smaller than a predetermined value as a plurality of selected groups, selects at least one user that appears more than once in the selected groups as at least one selected user, and creates the power consumption model of the target user by using the at least one power consumption datum of the at least one selected user and the power consumption datum of the target user.

The method for creating a power consumption model provided by certain embodiments of the present invention is for use in an electronic apparatus. The electronic apparatus is stored with a power consumption datum for each of a plurality of users and a power consumption datum for a target user. The method for creating a power consumption model comprises the following steps of: (a) selecting a number of users from the users as a group; (b) creating a predicted model by using the power consumption data of the users in the group; (c) calculating a predicted power consumption value of the target user by using the predicted model; (d) calculating a difference between the predicted power consumption value and an actual power consumption value of the target user, wherein the actual power consumption value is contained in the power consumption datum of the target user; (e) repeating the steps (a), (b), (c), and (d) until a preset criterion is satisfied; (f) selecting those of the groups whose corresponding differences are smaller than a predetermined value as a plurality of selected groups; (g) selecting at least one user that appears more than once in the selected groups as at least one selected user; and (h) creating the power consumption model of the target user by using the at least one power consumption datum of the at least one selected user and the power consumption datum of the target user.

The non-transitory computer readable storage medium of certain embodiments of the present invention has a computer program stored therein. The computer program executes a method for creating a power consumption model after being loaded into a computing apparatus. The computer program comprises codes A to G. The code A enables the electronic apparatus to select a number of users from the users as a group, the code B enables the electronic apparatus to use the power consumption data of the users in the group to create a predicted model, the code C enables the electronic apparatus to calculate a predicted power consumption value of the target user by using the predicted model, the code D enables the electronic apparatus to calculate a difference between the predicted power consumption value and an actual power consumption value of the target user, and the code E enables the electronic apparatus to repeatedly execute the codes A, B, C, and D until a preset criterion is satisfied. Furthermore, the code F enables the electronic apparatus to select those of the groups whose corresponding differences are smaller than a predetermined value as a plurality of selected groups, the code G enables the electronic apparatus to select at least one user that appears more than once in the selected groups as at least one selected user, and the code H enables the electronic apparatus to create the power consumption model of the target user by using the at least one power consumption datum of the at least one selected user and a power consumption datum of the target user.

According to certain embodiments of the present invention, predicted models are created repeatedly for the target user by using the power consumption data of users in different groups, and differences between predicted power consumption values predicted by these predicted models and the actual power consumption value are calculated until a preset criterion is satisfied. Then, those of the differences that are smaller than a predetermined value are selected, and those of the groups whose corresponding differences are smaller than the predetermined value are selected as selected groups. Next, at least one user that appears more than once in the selected groups is selected as at least one selected user. The selected users are just users having power consumption behaviors similar to that of the target user.

Afterwards, the power consumption model of the target user is created by using at least one power consumption datum of the at least one selected user and the power consumption datum of the target user. Since the present invention creates the power consumption model by using the power consumption data of users having power consumption behaviors similar to that of the target user and the power consumption datum of the target user himself/herself, a power consumption model suitable for the target user can be created without gathering the power consumption data of the target user for a long period of time.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A depicts an apparatus 1 according to a first embodiment of the present invention;

FIG. 1B depicts an example of calculating differences by using a predicted model; and

FIG. 2 depicts a flowchart diagram of a second embodiment of the present invention.

### DETAILED DESCRIPTION

In the following description, the apparatus and the method for creating a power consumption model and the non-transitory computer readable storage medium thereof provided by the present invention will be explained with reference to example embodiments thereof. However, these example embodiments are not intended to limit the present invention to any specific examples, embodiments, environment, applications, or particular implementations described in these embodiments. Therefore, description of these embodiments is only for purpose of illustration rather than to limit the present invention. It should be appreciated that in the following embodiments and the attached drawings, elements unrelated to the present invention are omitted from depiction.

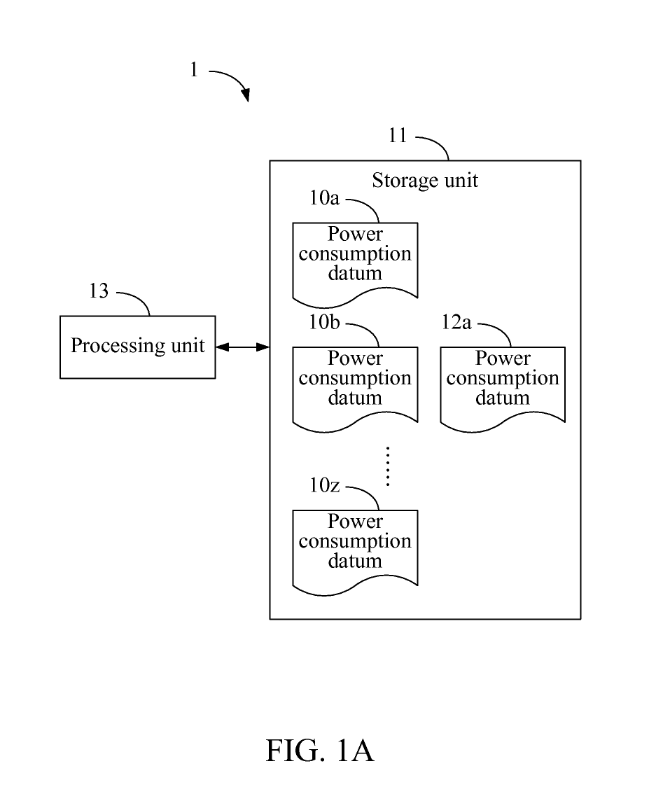

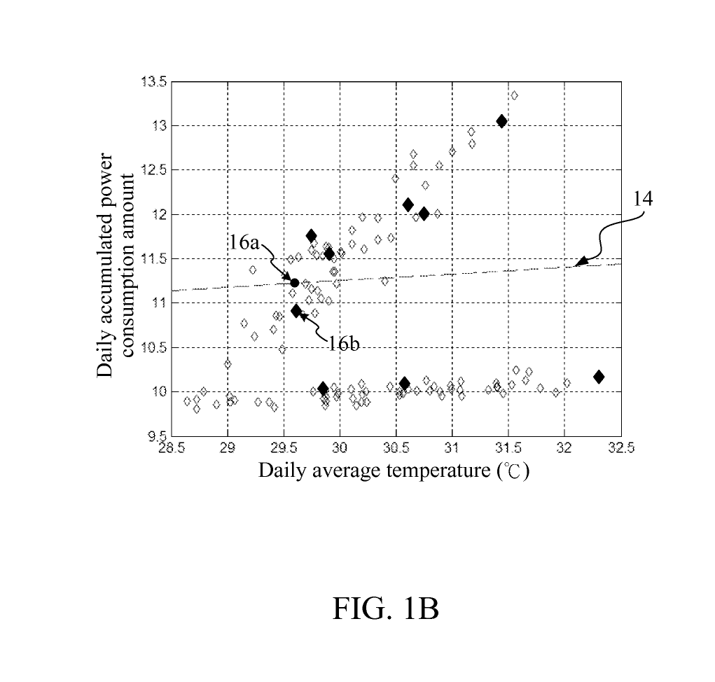

A first embodiment of the present invention is an apparatus 1 for creating a power consumption model, a schematic view of which is depicted in FIG. 1A. The apparatus 1 comprises a storage unit 11 and a processing unit 13 electrically connected to each other. The storage unit 11 may be a memory, a floppy disk, a hard disk, a compact disk (CD), a mobile disk, a magnetic tape, a database, or any other storage media or circuit with the same function and well known to those of ordinary skill in the art. The processing unit 13 may be any of various processors, central processing units (CPUs), microprocessors or other computing apparatuses known to those of ordinary skill in the art.

The storage unit 11 is stored with a plurality of power consumption data 10a, 10b, . . . , 10z, each of which corresponds to one user. In other words, the storage unit 11 is stored with a power consumption datum for each of a plurality of users. Furthermore, the storage unit 11 is also stored with a power consumption datum 12a of a target user. Each of the power consumption data 10a, 10b, . . . , 10z and 12a may be a power consumption time duration, a power consumption frequency, an accumulated power consumption amount, and/or other related information that can indicate the power consumption of a user. For example, each of the power consumption data 10a, 10b, . . . , 10z and 12a may comprise a sub-datum, which records a daily accumulated power consumption amount of the user at different daily average temperatures.

In this embodiment, users have been filtered by the processing unit 13 according to an objective condition (e.g., the income level, the family size, the age, the occupation, and/or the residential area) firstly. Therefore, the users corresponding to the power consumption data 10a, 10b, . . . , 10z and 12a stored in the storage unit 11 all satisfy the same objective condition (e.g., having 4 family members). It should be appreciated that the processing unit 13 may not filter the users according to an objective condition in advance in other embodiments.

Furthermore, abnormal power consumption data has also been excluded by the processing unit 13 in this embodiment. Therefore, no abnormal power consumption data is included in the power consumption data 10a, 10b, . . . , 10z and 12a stored in the storage unit 11. The processing unit 13 can exclude the abnormal power consumption data in various ways, one of which can be found in the disclosure of Taiwan patent application No. 10014455. It should be appreciated that the processing unit 13 may not exclude the abnormal power consumption data but perform the subsequent processing directly with all of the power consumption data in other embodiments.

The focus of this embodiment is to find out users that have similar power consumption behaviors to the target user from the plurality of non-target users and using the power consumption data of these users (i.e. the users that have similar power consumption behaviors to the target user) to create a power consumption model for the target user for subsequent power consumption prediction. Operations of this embodiment will be detailed hereinbelow.

The processing unit 13 selects a number of users from the users (i.e., the users other than the target user) as a group (for example, selecting ten users from one thousand users) and uses the power consumption data of the users in this group to create a predicted model. For example, the processing unit 13 may create the predicted model by using a first-order linear regression equation, a support vector machine (SVM), an artificial neural network, an auto-regressive integrated moving average (ARIMA) model, or other model creating mechanisms.

Now, a particular example will be described. It is assumed that a power consumption model for predicting a daily accumulated power consumption amount according to the daily average temperature is to be created for the target user. Then, an equation y=mx+b may be used as the predicted model, wherein the variable x represents the temperature, the variable y represents a power consumption amount, and the constants m and b may be obtained from the following Equations (1) and (2) respectively.

$$\begin{matrix}m = \frac{n {\sum }_{i = 1}^{n} {x}_{i} {y}_{i} - ( {\sum }_{i = 1}^{n} {x}_{i} \times {\sum }_{i = 1}^{n} {y}_{i} )}{n {\sum }_{i = 1}^{n} {x}_{i}^{2} - {( {\sum }_{i = 1}^{n} {x}_{i} )}^{2}} = \frac{\overline{xy} - \overline{x} \cdot \overline{y}}{\overline{{x}^{2}} - {\overline{x}}^{2}} & ( 1 ) \\ b = \overline{y} - m \overline{x} = \frac{1}{n} ( {\sum }_{i = 1}^{n} {y}_{i} - m {\sum }_{i = 1}^{n} {x}_{i} ) & ( 2 )\end{matrix}$$

In the above Equations (1) and (2), the constant n represents the number of the selected users (for example, if ten users are selected from one thousand users, then the constant n is 10). Furthermore, variables xᵢ and yᵢ are the power consumption data of the i^{th} user, wherein the variable xᵢ represents the temperature and the variable yᵢ represents the power consumption amount. Once the constants m and b are calculated by the processing unit 13, the predicted model y=mx+b can be created.

It is noted that people ordinary skilled in the art should be able to appreciate the details of creating the predicted model by using the power consumption data of multiple users when the SVM, the artificial neural network, the ARIMA model, or other model creating mechanisms are used. Hence, the details of using those mechanisms will not be further described herein.

After the predicted model is created, the processing unit 13 further calculates a predicted power consumption value of the target user by using the predicted model. Then, the processing unit 13 calculates a difference between the predicted power consumption value and an actual power consumption value of the target user. The actual power consumption value is contained in the power consumption datum 12a of the target user. Now, the aforesaid particular example will be further described with reference to FIG. 1B. In FIG. 1B, the dotted line 14 represents the predicted model created for the target user by the processing unit 13, wherein each hollow diamond represents a power consumption datum of a non-target user and each solid diamond represents a power consumption datum of the target user. For example, for a daily average temperature of 29.6° C., the processing unit 13 calculates a predicted power consumption value 16a at the daily average temperature of 29.6° C. according to this predicted model. Then, the processing unit 13 calculates a difference between the predicted power consumption value 16a and an actual power consumption value 16b of the target user at the daily average temperature of 29.6° C. The processing unit 13 calculates predicted power consumption values at different daily average temperatures, calculates corresponding differences, and takes a sum of the differences as a difference representing the group.

Subsequently, the processing unit 13 selects a number of users from the users as a group again, wherein the users selected this time are not completely the same as those selected previously. Then, the processing unit 13 creates a predicted model again by using the power consumption data of the users in this group. Similarly, the processing unit 13 calculates a predicted power consumption value of the target user again by using this predicted model and calculates a difference between the predicted power consumption value and an actual power consumption value of the target user. The processing unit 13 repeatedly executes the aforesaid operations until a preset criterion is satisfied. For example, the preset criterion may be that the differences calculated according to all of the groups are in a normal distribution.

Then, the processing unit 13 selects those of the differences that are smaller than a predetermined value. The processing unit 13 selects those of the groups whose corresponding differences are smaller than the predetermined value as the selected groups. Then, the processing unit 13 selects at least one user that appears more than once in the selected groups as at least one selected user. Afterwards, the processing unit 13 creates the power consumption model of the target user by using at least one power consumption datum of the at least one selected user and the power consumption datum of the target user. Similarly, the processing unit 13 may use a first-order linear regression equation, an SVM, an artificial neural network, an ARIMA model, or other models to create the power consumption model by using the at least one power consumption datum of the at least one selected user and the power consumption datum of the target user.

Subsequently, the processing unit 13 can predict tomorrow's predicted power consumption amount of the target user according to the power consumption model and a piece of predicting information (e.g., tomorrow's daily average temperature).

As can be known from the above descriptions, the apparatus 1 of this embodiment repeatedly creates the predicted models for the target user by using the power consumption data corresponding to different groups and calculates differences between the predicted power consumption values predicted by the predicted models and the actual power consumption value until the differences generated by all of the predicted models satisfy a preset criterion. Then, the apparatus 1 of this embodiment selects those of the differences that are smaller than a predetermined value, selects those of the groups whose corresponding differences are smaller than the predetermined value as selected groups, and selects at least one user that appears more than once in the selected groups as at least one selected user. The selected users are just the users having power consumption behaviors similar to that of the target user.

Then, the apparatus 1 creates the power consumption model of the target user by using at least one power consumption datum of the at least one selected user and the power consumption datum of the target user. Since the apparatus 1 creates the power consumption model by using the power consumption data of the users having power consumption behaviors similar to that of the target user and the power consumption datum of the target user himself/herself, a power consumption model suitable for the target user can be created without gathering the power consumption data of the target user for a long period of time.

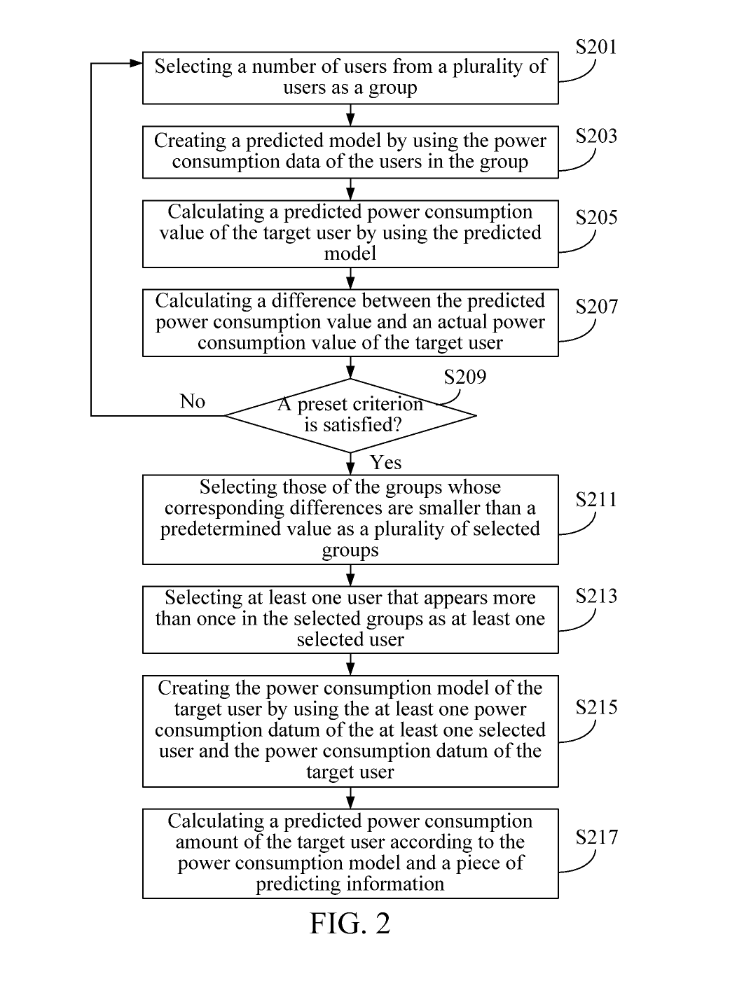

A second embodiment of the present invention is a method for creating a power consumption model and a flowchart diagram of which is depicted in FIG. 2. The method for creating a power consumption model may be used in an electronic apparatus (e.g., the apparatus 1 of the first embodiment). The electronic apparatus is stored with a power consumption datum for each of a plurality of users and a power consumption datum for a target user. Each of the aforesaid power consumption data is one of a power consumption time duration, a power consumption frequency and an accumulated power consumption amount or a combination thereof.

Firstly, step S201 is executed to select a number of users from the users as a group. Then, step S203 is executed to create a predicted model by using the power consumption data of the users in the group. For example, the step S203 is to create the predicted models by using one of a first-order linear regression equation, a support vector machine (SVM), an artificial neural network, an auto-regressive integrated moving average (ARIMA) model, or other model creating mechanisms. Then, step S205 is executed to calculate a predicted power consumption value of the target user by using the predicted model. Subsequently, step S207 is executed to calculate a difference between the predicted power consumption value and an actual power consumption value of the target user. The actual power consumption value is contained in the power consumption datum of the target user. Then, step S209 is executed to determine whether a preset criterion is satisfied. For example, the preset criterion is that the differences calculated according to all of the groups are in a normal distribution.

If the determination result of the step S209 is “no” (for example, the differences calculated corresponding to all of the groups are not in a normal distribution), then the steps S201, S203, S205 and S207 are executed again. It should be appreciated that the users selected every time the step S201 is executed should not be completely the same as those selected previously.

If the determination result of the step S209 is “yes” (for example, the differences calculated corresponding to all of the groups are in a normal distribution), then step S211 is executed to select those of the groups whose corresponding differences are smaller than a predetermined value as a plurality of selected groups. Then, step S213 is executed to select at least one user that appears more than once in the selected groups as at least one selected user. Subsequently, step S215 is executed to create the power consumption model of the target user by using the at least one power consumption datum of the at least one selected user and the power consumption datum of the target user. Finally, step S217 is executed to calculate a predicted power consumption amount of the target user according to the power consumption model and a piece of predicting information.

In addition to the aforesaid steps, the second embodiment can also execute all the operations and functions set forth in the first embodiment. How the second embodiment executes these operations and functions will be readily appreciated by those of ordinary skill in the art based on the explanation of the first embodiment, and thus will not be further described herein.

Moreover, the method for creating a power consumption model may be implemented by a computer program having a plurality of codes. The computer program is stored in a non-transitory computer readable storage medium. When the codes are loaded into an electronic apparatus, the computer program executes the method for creating a power consumption model described in the second embodiment. The aforesaid non-transitory computer readable storage medium may be a read only memory (ROM), a flash memory, a floppy disk, a hard disk, a compact disk, a mobile disk, a magnetic tape, a database accessible to networks, or any other storage media with the same function and well known to those skilled in the art.

According to the above descriptions, the predicted models are created repeatedly for the target user by using the power consumption data of users in different groups, and differences between predicted power consumption values predicted by these predicted models and the actual power consumption value are calculated until a preset criterion is satisfied. Then, those of the differences that are smaller than a predetermined value are selected, and those of the groups whose corresponding differences are smaller than the predetermined value are selected as selected groups. Next, at least one user that appears more than once in the selected groups is selected as at least one selected user. The selected users are just users having power consumption behaviors similar to that of the target user.

Afterwards, the power consumption model of the target user is created by using at least one power consumption datum of the at least one selected user and the power consumption datum of the target user. Since the present invention creates the power consumption model by using the power consumption data of users having power consumption behaviors similar to that of the target user and the power consumption datum of the target user himself/herself, a power consumption model suitable for the target user can be created without gathering the power consumption data of the target user for a long period of time.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for creating a power consumption model, comprising:
a storage unit, being stored with a power consumption datum for each of a plurality of users and a power consumption datum for a target user; and
a processing unit electrically connected to the storage unit, being configured to execute the following operations:
(a) selecting a number of users from the users as a group,
(b) creating a predicted model by using the power consumption data of the users in the group,
(c) calculating a predicted power consumption value of the target user by using the predicted model,
(d) calculating a difference between the predicted power consumption value and an actual power consumption value of the target user, wherein the actual power consumption value is contained in the power consumption datum of the target user,
(e) repeating the operations (a), (b), (c), and (d) until a preset criterion is satisfied,
wherein the processing unit further selects the groups whose corresponding differences are smaller than a predetermined value as a plurality of selected groups, selects at least one user that appears more than once in the selected groups as at least one selected user, and creates the power consumption model of the target user by using the at least one power consumption datum of the at least one selected user and the power consumption datum of the target user.

2. The apparatus as claimed in claim 1, wherein the preset criterion is that the differences are in a normal distribution.

3. The apparatus as claimed in claim 1, wherein the processing unit creates the predicted models by using one of a first-order linear regression equation, a support vector machine (SVM), an artificial neural network, and an auto-regressive integrated moving average (ARIMA) model.

4. The apparatus as claimed in claim 1, wherein each of the power consumption data is one of a power consumption time duration, a power consumption frequency, an accumulated power consumption amount, and a combination thereof.

5. The apparatus as claimed in claim 1, wherein the processing unit further calculates a predicted power consumption amount of the target user according to the power consumption model and a piece of predicting information.

6. A method for creating a power consumption model for use in an electronic apparatus, the electronic apparatus being stored with a power consumption datum for each of a plurality of users and a power consumption datum for a target user, the method for creating a power consumption model comprising:
(a) selecting a number of users from the users as a group;
(b) creating a predicted model by using the power consumption data of the users in the group;
(c) calculating a predicted power consumption value of the target user by using the predicted model;
(d) calculating a difference between the predicted power consumption value and an actual power consumption value of the target user, wherein the actual power consumption value is contained in the power consumption datum of the target user;
(e) repeating the steps (a), (b), (c), and (d) until a preset criterion is satisfied;
(f) selecting the groups whose corresponding differences are smaller than a predetermined value as a plurality of selected groups;
(g) selecting at least one user that appears more than once in the selected groups as at least one selected user; and
(h) creating the power consumption model of the target user by using the at least one power consumption datum of the at least one selected user and the power consumption datum of the target user.

7. The method as claimed in claim 6, wherein the preset criterion is that the differences are in a normal distribution.

8. The method as claimed in claim 6, wherein the step (b) creates the predicted models by using one of a first-order linear regression equation, a support vector machine (SVM), an artificial neural network, and an auto-regressive integrated moving average (ARIMA) model.

9. The method as claimed in claim 6, wherein each of the power consumption data is one of a power consumption time duration, a power consumption frequency, an accumulated power consumption amount, and a combination thereof.

10. The method as claimed in claim 6, further comprising the following step of:
calculating a predicted power consumption amount of the target user according to the power consumption model and a piece of predicting information.

11. A non-transitory computer readable storage medium, having a computer program stored therein, the computer program executing a method for creating a power consumption model, the computer program comprising:
a code A for enabling the electronic apparatus to select a number of users from the users as a group;
a code B for enabling the electronic apparatus to use the power consumption data of the users in the group to create a predicted model;
a code C for enabling the electronic apparatus to calculate a predicted power consumption value of the target user by using the predicted model;
a code D for enabling the electronic apparatus to calculate a difference between the predicted power consumption value and an actual power consumption value of the target user;
a code E for enabling the electronic apparatus to repeatedly execute the codes A, B, C and D until a preset criterion is satisfied;
a code F for enabling the electronic apparatus to select those of the groups whose corresponding differences are smaller than a predetermined value as a plurality of selected groups;
a code G for enabling the electronic apparatus to select at least one user that appears more than once in the selected groups as at least one selected user; and
a code H for enabling the electronic apparatus to create the power consumption model of the target user by using the at least one power consumption datum of the at least one selected user and a power consumption datum of the target user.
